(19) United States
(12) Patent Application Publication
(10) Pub. No.: US 2011/0129589 A1
(43) Pub. Date: Jun. 2, 2011

(54) Recycling Resources Between Aging Vessels

(75) Inventors: Daniel Martin Watson, Driftwood, TX (US); Billie Sunday Watson, Wimberly, TX (US)

(73) Assignee: ULTRA MATURATION, LLC, Dallas, TX (US)

(21) Appl. No.: 12/957,188

(22) Filed: Nov. 30, 2010

Related U.S. Application Data
(63) Continuation-in-part of application No. 12/248,603, filed on Oct. 9, 2008.
Application No. 12/248,603 is a continuation-in-part of application No. 11/850,795, filed on Sep. 6, 2007.

(51) Int. Cl. C12H 1/22

(52) U.S. Cl. 426/592; 99/277.1

(57) ABSTRACT

Systems and methods for accelerating the aging of distilled spirits are disclosed. The systems and methods may include increased reaction rates of ethanol with oxygen, acids, sugars, and/or other components within an ethanol mixture. The accelerated reactions may produce an aged alcohol in a matter of a few hours or days, whereas comparable alcohols aged conventionally would require many years. The accelerated aging of the ethanol may be performed to provide the end product with a desired flavor profile in a short period of time at a substantially reduced cost.

### CROSS-REFERENCE TO RELATED APPLICATIONS

This application is a continuation-in-part application of U.S. patent application Ser. No. 12/248,603, filed on Oct. 9, 2008, entitled “Ultrafast Method for Creating Aged Wood Flavored Alcoholic Beverages,” and is also a continuation-in-part of U.S. patent application Ser. No. 11/850,795, filed on Sep. 6, 2007, entitled “Method for Creating Ethanol-Containing Beverages,” the entire contents of which are hereby incorporated by reference.

### TECHNICAL FIELD

This disclosure relates to systems and methods for aging alcohols at an accelerated rate.

### BACKGROUND

Presently, distilled spirits, such as brandy, gin, tequila, scotch, whisky, vodka, and rum, are produced by distilling a fermented liquid to recover ethanol. The ethanol is aged in casks over a period of time, generally several years, to produce a desired flavor profile.

### SUMMARY

Systems and methods for accelerating the aging of distilled spirits are disclosed. The systems and methods may include increased reaction rates of ethanol with oxygen, acids, sugars, and/or other components within an ethanol mixture. The accelerated reactions may produce an aged alcohol in a matter of a few hours or days, whereas comparable alcohols aged conventionally would require many years. The accelerated aging of the ethanol may be performed to provide the end product with a desired flavor profile in a short period of time at a substantially reduced cost.

### DESCRIPTION OF THE DRAWINGS

FIG. 1 shows an example system for accelerated aging of alcohol.

FIG. 2A shows an example aerator within a reaction vessel, the aerator used to introduce a gas into a mixture within the reaction vessel.

FIG. 2B shows another example aerator within a reaction vessel.

FIG. 2C shows still another example having a plurality of aerators within a reaction vessel.

FIG. 3 shows an example system for capturing and recycling heat from waste liquid during distillation.

FIG. 4 is a graph illustrating an increase in kinetic energy of an alcoholic mixture during an accelerated aging process according to some implementations.

FIG. 5 is a graph illustrating a change in oxygen concentration over time during accelerated aging according to some implementations.

FIG. 6 is a graph illustrating oxygen concentrations in an alcoholic mixture during accelerated aging according to other implementations.

FIG. 7 is a graph showing changes in concentrations of organic acids and esters over time during accelerated aging according to some implementations.

FIG. 8 shows an example vapor collection system according to some implementations.

FIG. 9 is a flowchart for an example accelerated aging process.

FIG. 10 is an example control system for controlling various aspects of an accelerated aging system.

### DETAILED DESCRIPTION

The present disclosure describes systems and methods for accelerating the aging of distilled spirits. For example, an oxygen concentration may be increased in an ethanol-based solution obtained through distillation of fermented organic materials, such as grain, fruits, and/or vegetables. In general, the aging process of the distilled spirits may be accelerated by increasing the reaction rate of the alcohol with oxygen and/or acids in the solution. By increasing the reaction rate, the accelerated aging process may increase the rate that aldehydes and esters are produced in the solution, which are associated with aging of spirits. With respect to the oxygen reaction or aldehyde production, the aging may be accelerated by increasing the amount oxygen dissolved in the solution and/or increasing the kinetic energy of the oxygen and/or other components in the solution. Additional oxygen may be dissolved into the solution through pressure, addition of chemicals, bubbling, and/or other methods. In addition to increased pressure dissolving more oxygen in the ethanol-solution, increased pressure may assist in exposing chemicals in organic material to alcohols. For example, the increased pressure may break down cellular structures and/or compounds, which may, in turn, release expose additional chemicals to the alcohols. With respect to the reaction with the acids or ester production, the aging may be accelerated by increasing the amount of acid dissolved in the solution and/or increasing the kinetic energy of the acid and/or other components in the solution. Acid concentrations may be increased in the ethanol-based solution by directly adding acids (e.g., tannic) and/or adding organic material that includes acids (e.g., tannic, amino). Alternatively or in combination with increase component concentrations, the reaction rate between the oxygen and/or acids and the alcohol may be increased by increasing the kinetic energy of one or more components in the solution. For example, the kinetic energy may be increased by agitation, increased temperatures, increased pressures and/or other methods that increase the probability that two components may react with the ethanol-based solution and, hence, increase the aging rate of the ethanol solution. For example, an increased oxygen concentration in combination with increased kinetic energy may increase the reaction of the acid and alcohol with the ethanol to form aldehydes and esters, respectively, which may generate a sweet, smooth taste and pleasant aromas while also eliminating acids that may produce an undesirable taste. In some implementations, increasing the reaction rates of the ethanol with oxygen, acids, sugars, and/or other components can generate an aged alcohol in a few hours or days relative to conventional aging that requires years. Also, the accelerated again process accelerates the reduction of tannins in the ethanol-based solution to a matter hours or days relative to conventional aging that requires years to reduce tannin concentrations. Consequently, the accelerated aging of the ethanol may be performed to provide spirits with an aged flavor profile in a short period of time at a substantially reduced cost. For example, the disclosed aging process does not require large storage areas for years as well as significantly reduces loss due to evaporation. While distilled alcoholic spirits are described by example herein, nondistilled alcohols may also be used to increase the aging process without departing from the scope of the disclosure.

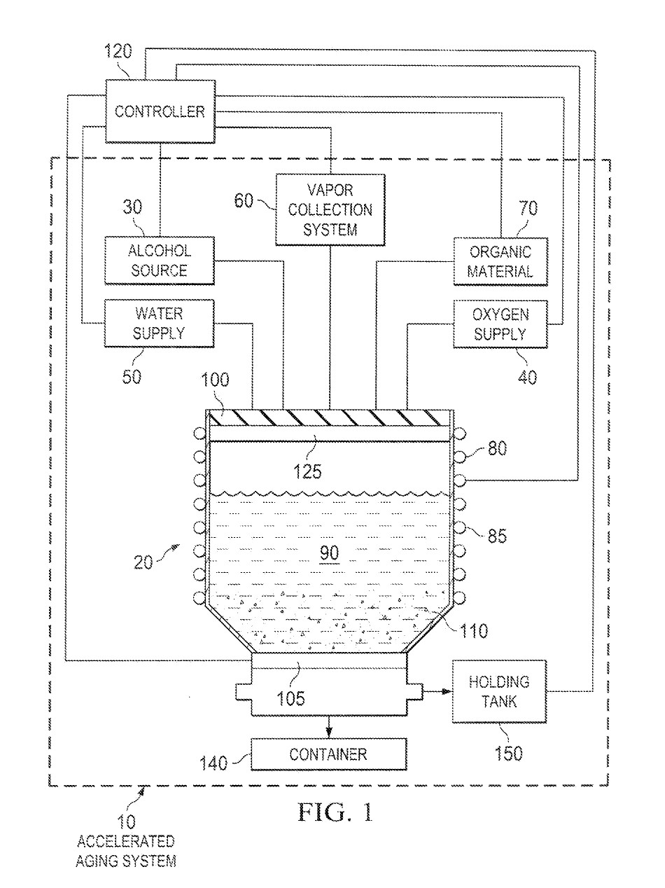

FIG. 1 shows an example system 10 for accelerating aging of spirits. The system 10 may include a reaction vessel 20, a source of alcohol 30, and an gas supply 40. The system 10 may also include a water supply 50 and a vapor collection system 60. Further, the system 10 may also include an organic material source 70 and a source 80 for increasing the kinetic energy of components in the solution 90 contained in the reaction vessel 20. The solution 90 may include ethanol, organic material, water, and/or other chemicals or additives. Further, in some instances, the solution 90 may contain none, some, or all of the identified ingredients without departing from scope of this disclosure. In still other implementations, the solution 90 may include ingredients and/or compositions other than those described.

The kinetic energy of the solution 90 may be increased, for example, by a kinetic energy source 95. Example kinetic energy sources 95 may include a pressure source to increase a pressure in the vessel 20, a heat source to increase a temperature of the solution 90, a mechanical agitation source, an electromagnetic source to increase the kinetic energy of the solution 90 electromagnetically, a an ultrasonic source to apply sonic energy to the solution 90, described in greater detail below, and/or other sources. For example, the source 95 may include multiple sources such as a pressure and heat source. As previously mentioned, increase pressure may increase oxygen dissolved in the solution 90. In addition to increased pressure dissolving more oxygen in the ethanol-based solution 90, increased pressure may assist in exposing chemicals in organic material to alcohols. For example, the increased pressure may break down cellular structures and/or compounds, which may, in turn, release expose additional chemicals to the alcohols. The system 10 may also include a filter 105. The filter 105 may be located at a base of the reaction vessel 20 and may be operable to filter the aged alcohol from other materials located in reaction vessel 20, such as the organic material 110, described in more detail below.

A seal 100 may be included to contain the solution 90 within the reaction vessel 20 before, during, and/or after processing of the solution 90. That is, the seal 100 may be engaged prior to introduction of one or more or any of the materials have been introduced into the reaction vessel 20. The seal 100 may be a pressure seal to contain the solution 90, particularly where the solution 90 may be maintained at an elevated pressure. Further, the seal 100 may be engaged after processing of the solution 90 has begun; the seal may be disengaged at one or more times during processing of the solution 90; or the seal 100 may be disengaged prior to completion of the processing of the solution 90. Further, in some instances, one or more components of the solution 90 may be added after formation of the seal 100 and/or after the aging process has been initiated. For example, the seal 100 may include apertures coupled to one or more of the ethanol source 30, gas supply 40, water supply 50, organic material source 70, or any other desired additive. However, in some instances, a seal, such as seal 100, may not be employed.

A volume of ethanol may be introduced into the reaction vessel 20 from the alcohol source 30. Ethanol, as recited herein, may be pure ethanol or a mixture of ethanol and other liquids such as spirits (e.g., beer, wine, whiskey, a bourbon, a rum, a brandy, an Armagnac, a cognac, a vodka, a tequila, an eau de vie). Further, the ethanol may have any desired alcohol content. For example, in some instances, the ethanol may have a 60 to 65 percent alcohol content, while in others the ethanol may be 68 to 75 percent alcohol. In still others, the ethanol may be 90 to 95 percent alcohol. However, as explained above, the ethanol may have any desired alcohol concentration. Additionally, all or a portion of the alcohol provided by the alcohol source 30 (or other source) may be an aged alcohol. For example, a spirit aged conventionally or according to one or more methods described herein, equivalent to a one to five year old aged alcohol may be added to the solution 90. Alcoholic spirits having a higher and/or lower equivalent age may also be used. In some instances, adding to the solution 90 at least a portion of aged alcohol introduces an alcohol containing large tannin concentration, for example. The aged alcoholic content added to the solution 90 may be selected based on a desired starting quantity of one or more molecular components desired. For example, a solution 90 having high concentrations of some sugars, acids, and/or other chemicals may be desired, and a quantity of one or more aged alcohols may be introduced into the solution 90.

A quantity of organic material 110 may also be introduced into the reaction vessel 20 from, for example, the organic material source 40. The organic material 110 may be used, for example, to introduce acids, sugars, and other chemicals into the solution 90. The introduced acids may react with the ethanol to produce esters and/or orthoesters. Such chemicals may provide aromas to the aged alcohol. The organic material 110 may include many different types of material. For example, organic material 110 may include one or more varieties of wood (collectively referred to hereinafter as “wood”), fruit or parts thereof, herbs, vegetables or parts thereof, one or more varieties of nuts, one or more varieties of flowers or parts thereof, plants (e.g., grapevine, agave stalks, seeds, flowers, roots, bark, leaves, oils, etc.), or combinations of one or more of these. Further, the organic material 110 may be formed in whole or in part of meat. For example, pork (e.g., bacon), beef, chicken, poultry, fish, reptiles, insects, arachnids, or any other meat or meat product or animals may be used in the organic material 110. Additionally, these organic materials 110 are provided merely as some possible sources and are not meant to be exclusive or exhaustive. Consequently, other types of organic materials 110 may be used and are within the scope of the disclosure.

In some implementations utilizing wood as the organic material 110, the wood may be processed prior to inclusion in the reaction vessel 20. In some instances, wood of a desired size may be selected. For example, the wood may be in the form of pieces or chips having a range of sizes from powder or chips 1-5 mm (e.g., high tannins) to planks (e.g., more natural wood sugars and caramel-type flavors). For example, in some cases, the wood may be in the form of splinters, whereas in other instances, the wood may be in the form of larger chips. The size selection of the wood may be determined based on the flavor desired in the resulting aged alcohol. As the size of the wood chips changes, the surface area available for contact with the alcohol also changes. That is, for a given mass of wood ships, the smaller chips have a larger surface area. Thus, more sugars and acids may be extracted, or the sugars and acids may be extracted at a faster rate than for chips of a larger size and may react with the alcohol at a faster rate. For example, smaller sized wood (e.g., wood ranging in the size 1-5 mm) may cause the production of a larger amount of tannins and/or lignins in the solution 90 to produce a dry tannic notes, while, in other instances, larger sized wood (e.g., wood ranging in the size of 1-12 in) may produce result in the introduction of caramel flavor and sugars into the solution 90 to provide greater sweetness and caramel notes.

The wood may be boiled, such as in water, prior to inclusion into the solution 90. For example, all or a portion of the wood may be boiled for up to two hours. In other cases, all or a portion of the wood may be boiled for approximately one hour. The wood may be boiled at temperatures of about 100. In some instances, when the wood has been boiled for a desired period, excess water may be boiled off and the wood deposited into the solution 90. In some instances, the wood may be rinsed with water. The liquid removed from the wood may be collected and used in an accelerated aging process. Generally, the wood may be boiled in preparation of non-bourbon aged alcohols, such as scotch, whisky, cognac, and vodka. However, the disclosure is in no way limiting, and the wood (or other organic material 110) may be boiled in the production of other alcohols.

In still other implementations, the wood may be roasted. The wood may be roasted at different temperatures for different periods to produce a desired flavor in the resulting aged alcohol. For example, in some instances, the wood may be roasted in the range of 280° F. to 410° F. Further, in some instances, the wood may be roasted for 2 to 4 hours between 325 and 400° F. Roasting the wood may produce mocha and/or vanillas flavors in the solution 90. In some instances, the wood may be roasted after boiling. Alternately, the boiling may be omitted prior to roasting. In some implementations, the wood may be raw, dehydrated, baked, roasted, charred, such as by heat or flame, boiled, roasted, and any combination of the forgoing.

Boiling and roasting the wood may increase the quantity of tannins and/or hemicellulose in the solution 90. Hemicellulose introduces acids and sugars into the solution 90. As a result, this increase increases the amount of acids and sugars in the solution 90 available for reactions that produce, for example, aldehydes and esters and other chemical reactions resulting from the foregoing. Additionally, sugars may be caramelized by, for example, removal of the water out of the solution 90.

Carbon, such as in the form of charcoal may also be included in the solution 90. For example, a portion of the wood may be converted into charcoal prior to introduction in the solution 90. Alternatively, charcoal may be separately obtained and included in the solution 90. For example, the addition of carbon into the solution 90 may produce a smooth flavor, forms enhanced vanillas and/or sweentness, and/or cleaning off notes. The charcoal may also act as a filter to remove impurities from the resulting aged alcohol. The solution 90 may be filtered using other methods such as cold filtering, carbon filtering, micro fiber filtering, and/or others. In some instances, oak charcoal may entirely or partially form the carbon contribution. In other instances, activated carbon may be added. Further, in some implementations, charcoal for introduction into the solution 90 may be formed, at least in part, from wood previously boiled and/or roasted.

In some instances, carbon, such as in the form of charcoal, may be in introduced into the solution 90 in an amount within the range of 1 to 30 grams per one and a half liters of ethanol. Also, in some cases, carbon in an amount within the range of 2 to 25 grams per one and a half liters of ethanol may be used. For example, in some instances, 5 grams of carbon per one and a half liters of ethanol may be used. However, carbon in larger concentrations or lower concentrations may also be used. For example, in some instances, charcoal in the amount of thirty grams per one and a half liters of ethanol may be introduced into the solution 90.

Wood may be prepared using one or more of the manners described. For example, in some cases, the wood may be prepared by sequential boiling, roasting, and charring to produce charcoal. In other cases, the sequence of these events may be changed. Further, in still other instances, the one or more of these treatments may be eliminated while others may be retained. Further, in other implementations, all or a portion of the wood may not be subjected to these treatments prior to inclusion in the solution 90. Still further, the wood may be prepared in additional or different ways in addition to or in lieu of the treatments described.

While the above paragraphs described preparation of wood prior to inclusion into the reaction vessel 20, the above processing may be applied to any type of organic material 110. In other instances, other substances may be substituted for the organic material 110 or included in addition to the organic material 110. For example, acids, such as one or more organic acids, may be added with or in place of the organic material 110 to the solution 90. Example acids include citric acid, formic acid, one or more types of amino acids, tannic acid, as well as others (e.g., carboxylic acid, potassium permanganate, nitric acid; Chromium (VI) Oxide, Chomic acid). The acids and sugars react with the ethanol to produce esters and aromas.

In some instances, an amount of organic material 110 included in the solution 90 may be in the range of about 20 to 30 grams per one and a half liters of ethanol. In other instances, the amount of organic material added to the solution 90 may be greater or less than this range. For example, organic material between about 10 to 20 grams per one and a half liters ethanol may be used, while, in still other cases, organic material in the range of about 30 to 40 grams per one and a half liters ethanol may be used. In some implementations, the solution 90 may include organic material 110 less than 10 or greater than 40 grams per one and a half liters ethanol. Still, organic material less than or greater than these ranges may be used in other mixtures 90. For example in some instances, 28 grams of organic material per one and a half liters of ethanol may be used. Further, the organic material 110 may be a combination of one or more different types of organic materials, such as one or more of the organic materials described herein. Additionally, the organic material may be combined with one or more acids or other chemicals described above.

A volume of water from the water source 50 may also be added on one or more occasions to solution 90, such as prior to, during, and/or after the aging process. The amount of water added may be selected to produce an aged spirit with a desired ethanol concentration or proof. Further, water may increase the sweetness of the alcohol as a result of reaction of the water with hemicelluloses contained in some organic materials.

An increased oxygen content may also be formed in the solution 90. In some instances, the increased oxygen content may be produced by exposing or entraining a gas containing oxygen. Further, the gas may be applied to the solution 90 at increased pressures, i.e., above atmospheric pressure. In some instances, the gas may be pure or substantially pure oxygen, air, air with an enhanced or increased oxygen content, a component of other gases, or a combination of one or more of these gases. In some instances, oxygen may form 40% of the gas by volume. In other instances, oxygen may form a larger or smaller percentage of the additive. For example, in some cases, oxygen may form 45%, 50%, 55%, any percentage therebetween, or higher percentage, e.g., 100% of the additive. Alternatively, oxygen may form 35%, 30%, 25%, any range therebetween, or an even lower percentage. The amount of oxygen applied to the solution 90 may depend upon a desired flavor or the resulting alcohol or for any other reason.

In some cases, alternatively or in addition to oxygen, the gas may contain an inert component(s) (e.g., nitrogen, argon), for example, to lessen the risk of combustion. This may be particularly important where the gas is being introduced to the solution 90 at high pressures. Applying the gas to the ethanol under increased pressure exposes a greater quantity of oxygen to the ethanol, thereby making more oxygen available for reaction with the ethanol and, consequently, expediting the reaction rate therebetween. In the case that the solution 90 includes wine, the gas supply 40 may solely supply non-oxygen gases to the vessel 20 such as inert gases.

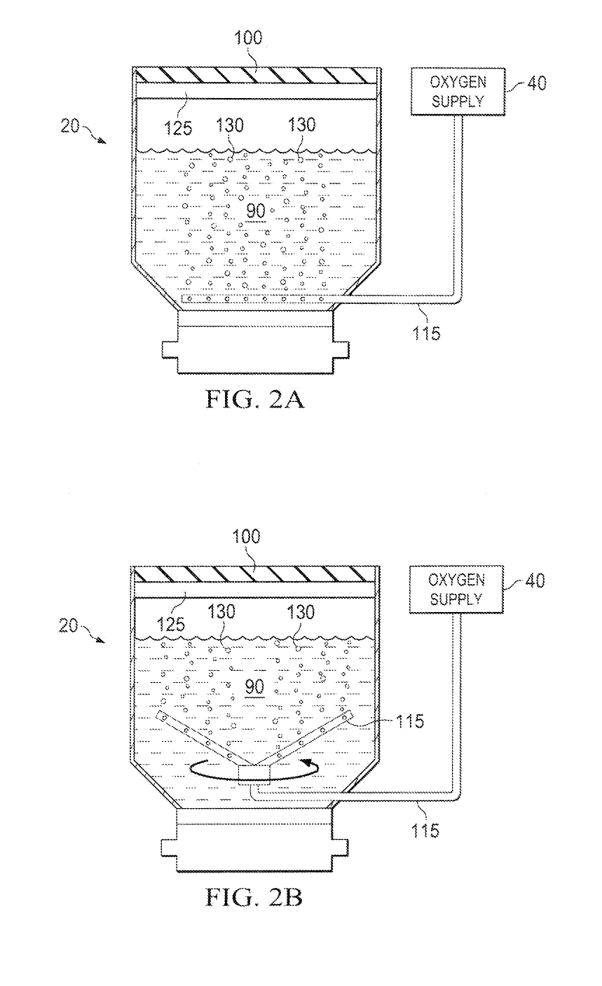

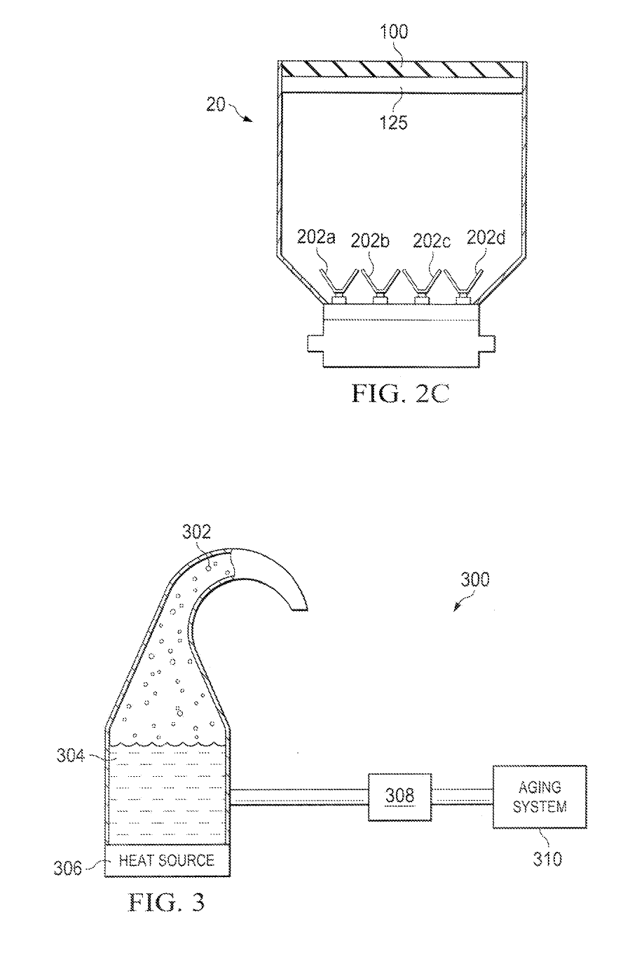

In some instances, the solution 90 may be aerated with the oxygen-containing gas, such as by bubbling the gas through the solution 90, as shown in FIG. 2. In FIG. 2, an aerator 115 may bubble the gas 130 into the ethanol solution 90 in the reaction vessel 20. In the example shown, the aerator 115 is coupled to the gas supply 40. In some instances, the aerator 115 may be a length of perforated tubing. However, the aerator 115 may be any other device adapted to introduce the oxygen-containing gas into the solution 90. Also, in some implementations, the solution 90 may be showered or flowed into itself (such as in the form of a shower or waterfall) in order to aerate the solution 90. In some implementations, the aerator 115 may rotate at one or more speeds during the accelerated aging process to assist in dissolving oxygen and/or increasing the kinetic energy of components in the solution 90.

FIG. 2B illustrates a further example implementation in which the solution 90 may be agitated while the oxygen-containing gas is simultaneously bubbled therethrough. In the example implementation shown, the aerator 115 may both bubble the oxygen-containing gas into the solution 90 as well as rotate in order to mechanically agitate the solution 90. In other implementations, agitation and aeration may be performed separately. In other instances, the solution 90 may be exposed to the gas without being aerated.

FIG. 2C show a further example in which the solution 90 may be agitated by a plurality of aerators 202a, 202b, 202c, and 202d. The aerators 202a-202d may rotate about a central axis respectively thereof. In some instances, one or more of the aerators 202a-202d may also include one or more apertures through which oxygen or an oxygen-containing material may be introduced into the ethanol solution 90. Thus, the aerators 202a-202d may be utilized to agitate and increase the kinetic energy of the ethanol solution 90 and promote dissolution of oxygen in the solution 90. While four aerators 202a-202d are show, the disclosure is not so limited. Rather, more or fewer aerators may be included.

In still other implementations, the oxygen content of the solution 90 may be increased in other ways. In some instances, the oxygen content of the solution 90 may be increased chemically, such as by the introduction of a chemical that releases oxygen in solution. For example, the oxygen concentration of the ethanol may be increased by the addition of hydrogen peroxide. The hydrogen peroxide may dissociate in the solution 90 to release oxygen. However, other chemical additives may be used.

While examples of mechanical agitation of the solution 90 are described above, other methods of agitation are also within the scope of the disclosure. For example, agitation of the solution 90 may be accomplished with increased pressure. In some cases, the increased pressure may be applied at a constant level over time. In other cases, the pressure may be made to fluctuate over the course of the aging process. For example, at a start of the aging process, pressure of the solution 90 may be increased from an initial value to a higher value over a desired period, maintained at the increased pressure for a second period, and decreased to a further pressure over a third period. Further, fluctuation of pressure, such as by ramping up and ramping down pressure of the solution 90 may be performed any number of times, and each stage of the pressurization of the solution 90 may occur over any desired time period. Thus, in some instances, pressure of the solution 90 may be cycled over time. Increased pressure may be accomplished by, for example, application of a fluid (e.g., a gas, such as an oxygen-containing gas) under pressure. In other instances, the pressure may be increased by increasing a temperature of the solution 90.

The increased pressures that may be applied within the reaction vessel 20 forces oxygen to dissolve in the solution 90. Oxygen from the oxygen source 40, oxygen released from chemically and physically breaking down the organic material 110 (e.g., wood), and releasing air pockets in the organic material 110, for example, provide for increasing the oxygen content dissolved in the solution 90.

Dissolving more oxygen within the solution 90 allows for more oxygen to react with other constituents within the solution 90. For example, the dissolved oxygen may react with the ethanol, acids, and sugars to accelerate the aging of the alcohol.

In other implementations, the agitation of the solution 90 may be accomplished with magnetic wave fluctuations. Agitation may also be accomplished sonically with ultrasonic waves. Further, agitation may be accomplished using a single agitation method exclusively or a combination of several agitation methods may be used simultaneously or different methods or combinations thereof may be used at different times during the aging process.

Agitation of the solution 90 may be utilized to increase the kinetic energy of the solution 90. The increased kinetic energy may increase the reaction rate of the ethanol and oxygen and acids in the solution 90, increase the chemical and physical breakdown of the organic material to release sugars and acids into the solution 90, release air pockets in the solution 90, aid in dissolving oxygen in the solution 90, and/or perform other functions.

Therefore, the solution 90 may be agitated in any number of ways. For example, as stated above, the solution 90 may be aerated with the gas. The solution 90 may also be agitated mechanically, e.g., with a stirring member without aeration of an oxygen-containing gas. Still further, in some implementations, agitation may be accomplished using a combination of one or more of the forms described herein or wholly or in part in other ways.

Ethanol from the ethanol source 30 and organic material 110 from the organic material source 70 may be added to the reaction vessel 20. As indicated above, water, such as from the water source 50, may also be added to the solution 90 prior to initiation of the aging process. A substantially air-tight seal 100 may be formed. As also indicated above, one or more of the ingredients of the ethanol solution 90 may be added before or after formation of the seal 100. In some instances, the solution 90 may occupy 85 to 90 percent of the volume of the reaction vessel 20 confined by the seal 100. The confined volume may be considered to be the volume of the reaction vessel 20 bounded by the seal 100 and the walls of the reaction vessel 20. In other instances, the solution 90 may occupy more or less of the confined volume of the reaction vessel 20. For example, in some instances, the solution 90 may occupy 70 to 95 percent of the confined volume. Still other volume percentages are within the scope of the disclosure. The remaining volume of the reaction vessel 20 (“gas volume 125”) may be occupied by an oxygen-containing gas, such as air, oxygen-enhanced air, pure or substantially pure oxygen, or any other desired gas. Further, the gas occupying the gas volume 125 may be identical to the gas provided by the oxygen source 40, for example, in those instances where the oxygen source 40 supplies a gas. The gas volume 125 may be maintained constant throughout the aging process or some portion thereof. In other cases, the gas volume 125 may change during the aging process. In some instances, the pressure maintained within the reaction vessel 20 at least during a part of the accelerated aging process may be within the range of 1,000 psig to 2,000 psig. In other instances, the pressure may be maintained at a lower pressure. For example, in some cases, the pressure may be maintained within the reaction vessel 20 during at least a portion of the accelerated aging process may be 500 psig or lower. In other instances, pressures up to 3,000 psig or higher may be used during at least a portion of the aging process.

In some instances, the solution 90 may be maintained at a pressure of 1000 psig to 3000 psig. In other instances, the pressure within the reaction vessel 20 may be maintained at a higher (e.g., 60,000 psig) or lower pressure. For example, the pressure of the solution 90 may vary based upon the kinetic energy source 95 being utilized. In the example system 10 shown in FIG. 1, the kinetic energy source 95 includes coiled tubing through which a fluid may be passed. During the aging process, a heated fluid may be passed through the coiled tubing in order to increase a pressure of the solution 90 within the reaction vessel 20. In some instances, kinetic energy source 95 may be used to heat the solution 90 to a temperature within a range of 160° F. to 180° F. However, the solution 90 may be heated to temperatures greater than or less than the indicated temperature range. Particularly, the solution 90 may be heated with the kinetic energy source 95 to maintain a desire pressure within the reaction vessel 20.

Some instances of the accelerated aging process may not involve application of increased pressure to the solution 90. In such instances, the solution 90 may be heated to a desired temperature. For example, the temperature of the solution 90 may be increased to a temperature of 160° F. to 180° F. Vapor that may be produced from the heated solution 90 may be captured by a vapor collection system, such as a vapor collection system 60. The solution 90 may be aerated to increase an amount of oxygen dissolved therein. In some instances, the mixture may be sprayed, showered, or otherwise flowed into itself, such as with a waterfall. Alternately, or in combination, kinetic energy of the mixture may be increased through agitation. For example, the mixture may be agitated with an aerator 115, such as the blender-type aerator shown in FIG. 3 or the aerator 115 shown in FIG. 2. The blender-type aerator 115 shown in FIG. 3 may be used to both agitate, e.g., stir the solution 90 at a desired speed, and aerate the solution 90 with an oxygen-containing gas. Other types of agitators may also be used.

A temperature of the heated fluid may be carefully controlled. The temperature of the circulating fluid may be controlled to gradually increase the pressure of the solution 90, maintain the solution 90 at a desired pressure, modulate the pressure 90 over a defined time period, and/or gradually decrease the temperature solution 90. Further, in some instances, a cool liquid may be circulated in the tubing to cool the solution 90.

FIG. 3 shows an example system 300 for capturing and recycling heat from waste liquid resulting during distillation. As shown, a heat source 306 may be applied to waste liquid 304 to cause alcohol 302 contained in the waste liquid to be evaporated. The alcohol 302 may be condense and collected. The waste liquid 304 may be circulated through a transfer device 308. Similarly, an ethanol solution in an aging system 310 may also be circulated through part of the transfer device 308. In some instances, excess or waste heat from the waste liquid 304 may be transferred to the ethanol solution in order to promote the accelerated aging process in the aging system 310.

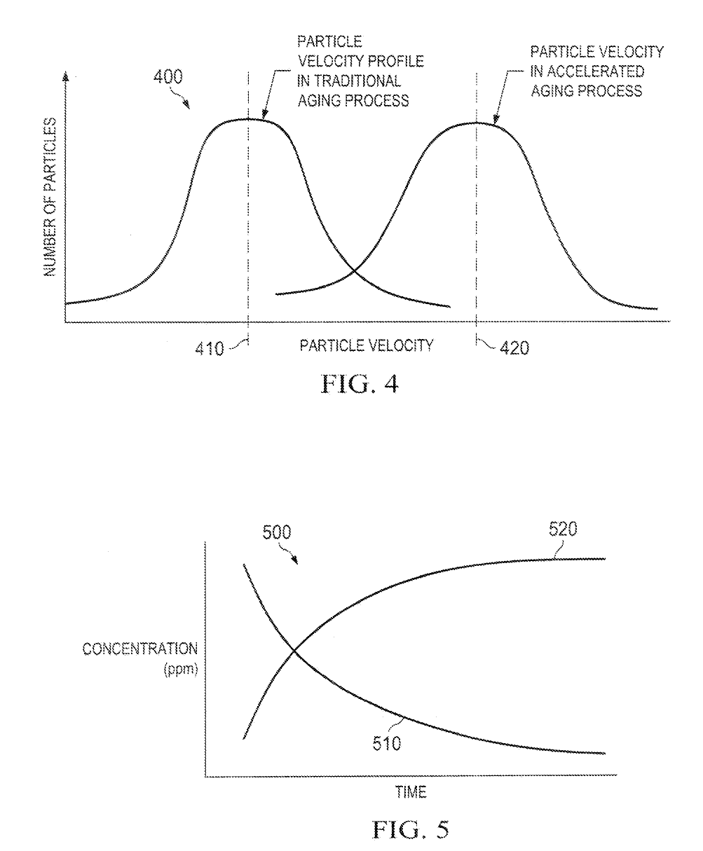

FIG. 4 shows an example graph 400 of the kinetic energy of the solution 90. Particularly, FIG. 4 shows the average molecular velocity 410 of an alcoholic mixture in a traditional aging processes and the average molecular velocity 420 during the accelerated aging process. As can be seen, the mean molecular velocity (Vmean) of one or more components may be shifted or increased during the accelerated aging process. As a result, the reaction of the ethanol and the various other components, such as oxygen and acids, in the solution 90 may be accelerated.

Further, during the accelerated aging process, the gas supply 40 may provide oxygen at one or more occasions during the accelerated aging process. In some instances, the oxygen source 40 may provide oxygen on only one occasion, such as at the beginning of the accelerated aging process. Thus, the oxygen source 40 may only provide an initial amount of oxygen to the solution 90. In still other instances, the oxygen source 40 may provide oxygen to the solution 90 at one or more occasions during the accelerated aging process. In still other implementations, the oxygen source 40 may provide oxygen continuously during the accelerated aging process. For example, the oxygen source may constantly supply oxygen (such as in one or more of the forms discussed above) to the solution 90 to maintain a desired oxygen concentration within the reaction vessel 20. The oxygen may be applied constantly in order to maintain the oxygen concentration within the reaction vessel 20 at a constant level.

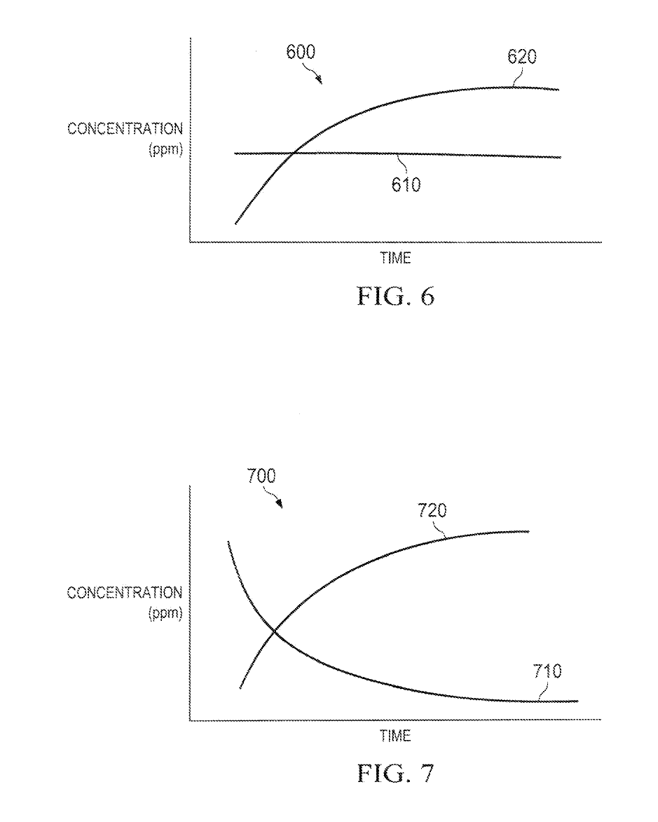

FIG. 5 shows an example graph 500 of the oxygen concentration (in parts per million (ppm)) in an accelerated aging process in which an oxygen concentration is not maintained at a constant level. FIG. 5 shows the concentration of both oxygen and aldehydes within solution 90 over time. As can be seen, as the oxygen is reacted and its concentration 510 within the solution 90 decreases, the concentration of aldehydes 520 increases. FIG. 6 shows a similar graph 600 in another example accelerated aging process in which the oxygen concentration 610 is maintained within the reaction vessel 20 at a constant level. Again, the aldehyde concentration 620 increases over time.

FIG. 7 shows an example graph 700 illustrating a change in concentration of organic acids 710 and esters 720 as the accelerated aging process continues. As shown, the organic acids react within the solution 90 to produces esters, the concentration of organic acids 710 decreases while the concentration of esters 720 increases.

Further, the accelerated aging process described herein also produces a higher yield, since storage of the alcohol for extended periods of time in porous casks may be avoided. As a result, loss due to evaporation (also known as “angel's share”) is avoided. Further, the cost associated with extended storage, e.g., warehouses, casks, labor to periodically handle the casks, etc., may also be avoided. Therefore, the present disclosure provides for a more efficient and cost effective process for producing aged spirits.

The vapor collection system 60 may be utilized to collect vapors from the solution 90 during the accelerated aging process. The vapor collection system 60 may collect vapors continually during the accelerated aging process or at one or more distinct periods during the accelerated aging process, such as when seal 100 is released. Also, the vapor released at the conclusion of the aging process may be captured by the vapor collection system 60.

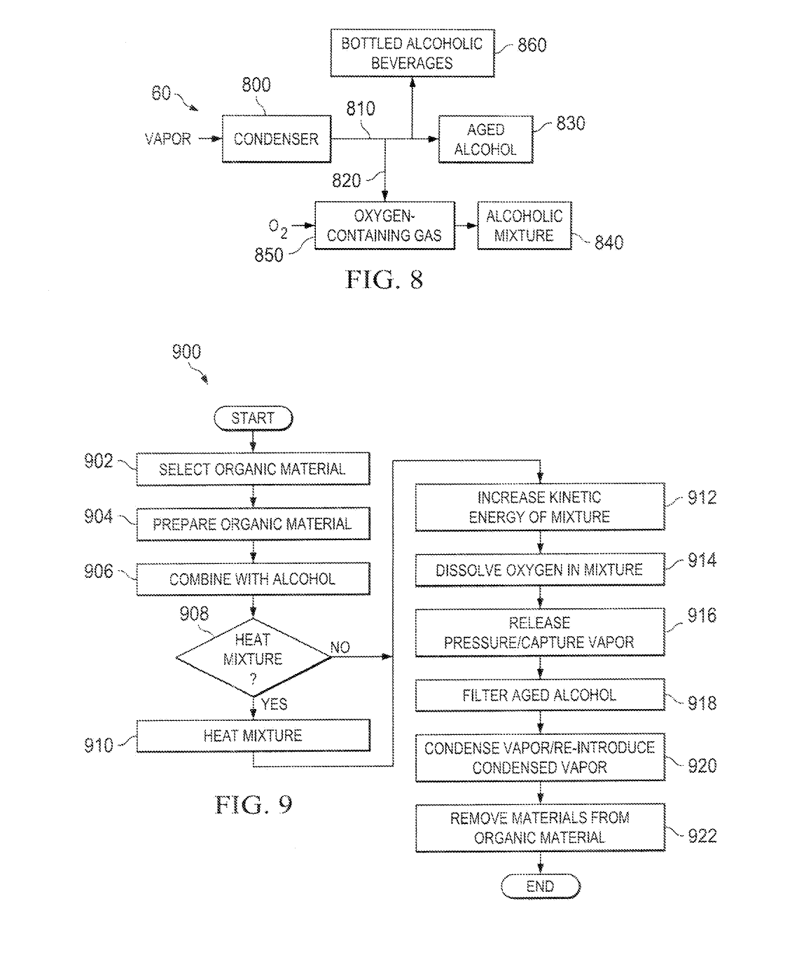

FIG. 8 shows an example vapor collection system 60. The example vapor collection system 60 may include a condenser 800. The condenser 800 receives vapor from the system 10 and cools the vapor. In some cases, the vapor may be cooled into a liquid. In other instances, the vapor may be cooled while remaining in a gaseous or partially gaseous form. The cooled vapor may be directed into at least one of two paths 810 and 820. Along path 810, all or a portion of the vapor is added into the aged alcohol 830. Along path 820, all or a portion of the vapor may introduced into another alcoholic mixture 840 prior to or during an accelerated aging process. In some instances, the vapor may be mixed with oxygen-containing gas at 850 prior to being introduced into the mixture 840. At 860, all or a portion of the condensed alcohol may be packaged, such as in bottles. The bottled alcohol may be provided to consumers.

FIG. 9 shows an example method 900 for aging alcohol at an accelerated rate. At 902, one or more organic materials are selected. As indicated above, the organic material may include one or more of woods, fruits, plants, flowers, nuts, meats, or other desired organic materials. The organic material may be used to introduce, for example, acids, lignins, sugars, and other chemicals into an alcoholic mixture. Alternately, one or more of these chemicals may be added directly, as opposed to being introduced via a carrier material. At 904, the organic material is prepared.

At 906, a desired amount of the organic material may be selected and combined with the ethanol. Different amounts of the organic material may be selected depending on any number of factors, such as one or more of the factors described herein. For example, the type of aged alcohol to be produce, the age of the alcohol to be produced, a desired flavor of the produced alcohol, or other factors may be used in determining the amount of organic material to be used. Example amounts of organic material are described below.

At 908, a decision is made whether to heat the mixture. If yes, the mixture is heated to a desired temperature at 910. For example, the mixture may be heated to a temperature within the range of 160 to 180° F. In other instances, other temperatures may higher or lower than this range of temperatures. If no, step 910 is omitted, and the mixture is not heated. At 912, kinetic energy of the mixture may be increased by, for example, increasing a pressure of the mixture. Step 910 also increases the kinetic energy of the mixture and, in some instances, would increase a pressure of the mixture, for example, where a pressure seal is utilized. In some instances, pressure of the mixture may be increased to a pressure above 500 psig. Particularly, in some cases, the pressure of the mixture may be increased to 2,000 psig. Pressures other than those described may also be used.

At 914, oxygen may be dissolved in the mixture. Oxygen may be dissolved into the mixture, for example, by introducing an oxygen-containing gas and/or other oxygen releasing chemical into the mixture. The oxygen-containing gas or oxygen releasing chemical may be one or more of those described herein or any other suitable chemical. Further, the oxygen content of the mixture may be increased by agitating the mixture and/or passing an oxygen-containing gas through the mixture, e.g., by aerating the mixture.

The mixture may be processed for a desired period of time. For example, the mixture may be processed for a desired number of days. For example, the mixture may be processed between one to fourteen days. In other instances, the mixture may be processed for a longer or shorter period. In other instances, the solution 90 may be process for only a few hours such as less than 24 hours. At 916, when processing has concluded, in implementations including a pressure seal, the pressure seal may be released and any released vapor may be collected. The captured vapor may be cooled and subsequently used, for example, in one or more of the manners described herein. At 918, the aged alcohol may be separated from the organic material, such as by filtration. At 920, all or a portion of the condensed vapor may be reintroduced into the aged alcohol. As explained above, in other cases, all or a portion of the condensed vapor may be used as an additive in other accelerated aging processes. At 922, liquids and other materials may be removed from the organic material. For example, materials may be dissolved out of the organic material. These materials may also be used in other accelerated aging processes.

The accelerated aging process may be conducted for any period of time. For example, a duration of the accelerated aging process may be varied depending upon the solution 90, e.g., the constituents of the solution 90, the type of aged alcohol desired, e.g., a whisky, a bourbon, a rum, vodka, tequila, cognac, etc., or a desired taste of the aged alcohol. In the case of varying the duration of the accelerated aging process to achieve a desired taste, the duration may be altered in order to create what are traditionally defined to be alcohols of a certain age in years. For example, in some instances, a traditional twelve year old scotch may be prepared using the accelerated aging process in the range of a matter of hours to three to seven days, depending, for example, on others aspects of the accelerated aging process.

Referring again to FIG. 1, at or near the conclusion of the accelerated aging process, the solution 90 may be cooled. For example, in some instances, a cooling fluid, such as water, may be circulated through tubing forming a portion of the kinetic energy source 95. In other instances, the solution 90 may be cooled in other ways or the solution 90 may not be cooled after completion of the accelerated aging process. Where applicable, the pressure seal 100 may be released. The aged alcohol may be drained from the reaction vessel 20 through the filter 105 and transported to a desired location, such as a holding tank 150, to a bottling line, or some other destination, for example, to distribute or store the aged alcohol.

The organic material 110 may also be removed from the reaction vessel 20. The organic material 110 may be removed before or after the aged alcohol is removed from the reaction vessel. The organic material 110 may be removed, for example, through a base of the reaction vessel 20 and into a container 140. In some implementations, all or a portion of the organic material 110 used in an accelerated aging process may be used in one or more subsequent accelerated aging processes. For example, wood used as part of the organic material 110 may be processed and reintroduced into another accelerated aging process. For example, wood may be reheated to remove alcohol from the wood. The removed alcohol may be collected and introduced into the aged alcohol. Alternately, all or a portion of the collected alcohol may be used in a subsequent accelerated aging process. Further, the organic material 110 may be used in multiple later accelerated aging processes. Also, the wood may be transformed into charcoal. The processed organic material may be used in a subsequent accelerated aging process. In some examples, the organic material may be reintroduced without subsequent processing.

An example implementation of the accelerated aging process for production of bourbon may include the following. The organic material may include a quantity of oak wood chips. The wood chips may be boiled for an hour. Thereafter, the wood may be heated to remove excess water contained therein. The wood may be dried at a temperature of 350° F. for one hour and roasted at 380° F. for four hours. The organic material may also include carbon. For example, the carbon may be prepared from oak or other wood. The organic material may be added in a ratio of 28 grams per one and a half liters of ethanol. The carbon may be added at a ratio of five grams per one and a half liters of ethanol. The mixture may be included in a reaction vessel, such as reaction vessel 20, with the mixture occupying approximately 80 percent of the volume of the reaction vessel while the gas volume may be 20 percent. For example, the gas may include air. Alternately or in addition, the gas may include an oxygen-containing gas.

A pressure seal, such as pressure seal 100, may be formed in the reaction vessel and the mixture may be pressurized to a pressure of 2,000 psig. The mixture may be pressurized by heating the mixture. For example, the mixture may be heated to 170° F. An oxygen-containing gas having an oxygen content of 40 percent by volume may be introduced into the reaction vessel. The mixture may be maintained at the described conditions for 24 hours. The mixture may be gradually cooled, such as by passing a cool fluid (e.g., cool water) through tubing wrapped around the reaction vessel.

An example scotch may be prepared substantially according to the implementation described above, except that the quantity of organic material may be 1 to 100 grams per one and a half liters of ethanol.

An example scotch may also be prepared substantially according to the bourbon recipe, except that the amount of carbon introduced is doubled to 10 grams of carbon per one and a half liters of ethanol. Further, the mixture-gas volume ratios may be different. Particularly, the mixture may occupy only 70 percent of the volume of the reaction vessel while gas volume may be 30 percent. This may also be referred to as 30 percent head space. The reduced organic material content reduces the sugars within the mixture.

An example vodka may be produced substantially as described above with respect to bourbon with the following changes. Vodka production may be produced without addition of organic material. Charcoal (e.g., carbon) may be included at a ratio of 30 grams of charcoal per one and a half liters of ethanol. The head space may be changed to between 10 and 15 percent.

An example grape brandy may be produced substantially as described above with respect to bourbon except that grape vine may be used as all or a part of the organic materials. Grape vine may be added at 20 grams per one and a half liters per ethanol. Also, the organic material may also include five grams of oak wood chips per one and a half liters of ethanol. The organic material may omit carbon. In other instances, some carbon may be introduced. One year old brandy may also be added to the mixture.

An example tequila may be produced substantially as described above with respect to bourbon except that the organic material may include agave stalk at 20 grams per one and a half liters of ethanol. Prior to introduction, the agave stalk may be fermented. Ten grams of oak wood chips per one and a half liters of ethanol may also be included in the organic material. The mixture may be heated to 180° F. for 4 hours.

While several example implementations for practicing the accelerated aging process are described, these are provided only as examples. Thus, other implementations incorporated various alterations to the organic material (e.g., composition, preparation, amount, etc.), the quantity of ethanol, the type of ethanol (e.g., proof, composition, etc.), operating temperatures, pressure, durations, oxygen source (e.g., type of oxygen source, pressure at which oxygen source is applied, etc.), as well as others, may be made without departing from the scope of the present disclosure.

Various components and operations of the system 10, such as controlling a temperature of fluid passing through the kinetic energy source 95; a pressure within the reaction vessel 20; a pressure of the oxygen-containing gas being introduced into the reaction vessel 20; an amount of ethanol, water, and/or organic material introduced into the reaction vessel 20; operations of the kinetic energy source 95; operations of a vapor collector 60 (described in more detail below), may be controlled by a controller, such as controller 120.

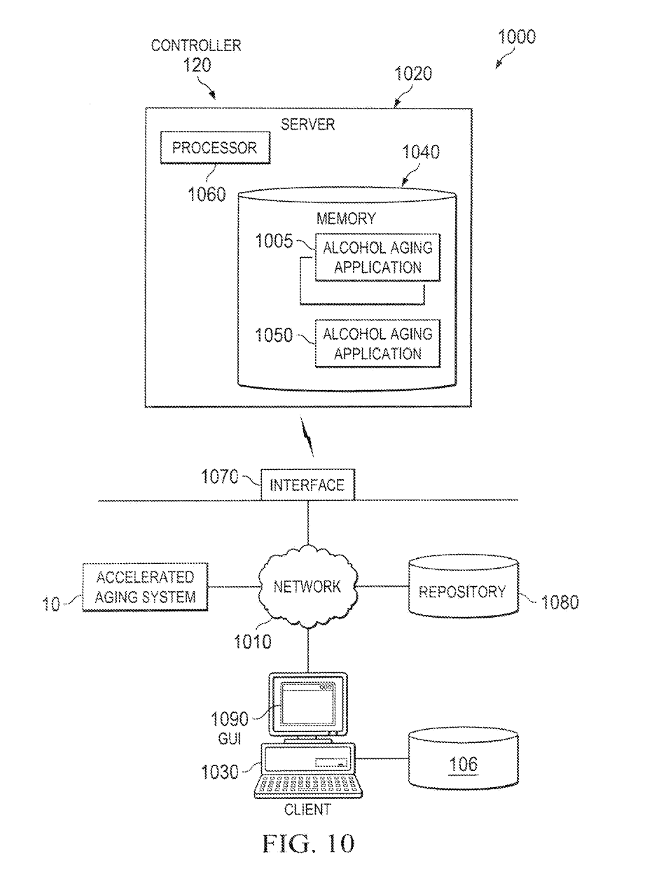

FIG. 10 shows system 10 and controller 120 as well as other components forming a control system 1000. The controller 120 may be used to control various aspects of the accelerated aging system 10. The system 120 may be operable to receive information from one or more of the components of system 10 (e.g., the reaction vessel 20, the source of alcohol 30, the oxygen source 40, the water supply 50, the vapor collection system 60, the organic material source 70, the kinetic energy source 90, the pressure seal 100, as well as others). Particularly, the controller 120 may be operable to control one or more of the operations of the system 10, including one or more of the activities described above. For example, the controller 120 may be operable to control pressures, temperatures, speeds, introduction of ingredients of a solution 90, as well as other desired operations of the system 10.

For example, the controller 120 may be operable to control an amount of ethanol to be introduced into the reaction vessel 20 and the type and quantities of materials forming the organic material introduced into the reaction vessel 20. The controller 120 may also be operable to control an amount of water, oxygen-containing gas, oxygen-releasing material, or any other desired materials to introduce into the reaction vessel 20 and when such materials are introduced during the aging process. The controller 120 may also be operable to form and/or release the pressure seal 100, agitate the solution 90 within the reaction vessel, or otherwise control the kinetic energy of the solution 90. Further, the controller 90 may be operable to control the various functions of the vapor collection system 60. Additional, fewer, or different operations and aspects of the system 10 may be defined by an alcohol aging application 1005. Thus, the controller 120 may administer or otherwise control various aspects of the control the system 10 by execution of the alcohol aging application 1005.

Control system 1000 may be a distributed client/server system that spans one or more networks, such as network 1010. In such implementations, data may be communicated or stored in an encrypted format using any standard or proprietary encryption algorithm. Alternately, data may be communicated or stored in an unencrypted formant. System 1010 may be in a dedicated environment—across a local area network or subnet—or any other suitable environment without departing from the scope of this disclosure. The system 1000 may include or be communicably coupled with a server 1020, one or more computers 1030, and network 1010.

Server 1020 may include an electronic computing device operable to receive, transmit, process, and store data associated with system 1000. Generally, FIG. 1 provides merely one example of computers that may be used with the disclosure. Each computer is generally intended to encompass any suitable processing device. For example, although FIG. 10 illustrates one server 1020 that may be used with the disclosure, control system 1000 can be implemented using computers other than servers, as well as a server pool. Indeed, server 1020 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 1020 may be adapted to execute any operating system including Linux, UNIX, Windows Server, or any other suitable operating system. According to one embodiment, server 1020 may also include or be communicably coupled with a web server and/or a mail server.

The server 1020 may include local memory 1040. Memory 1040 may include any memory or database module and may take the form of volatile or non-volatile memory including, without limitation, magnetic media, optical media, random access memory (RAM), read-only memory (ROM), removable media, or any other suitable local or remote memory component. Illustrated memory 1040 may include, among other items, the alcohol aging application 1005, for example. In some instances, alcohol aging application 1005 may be conducted entirely on the server 1020. In other instances, alcohol aging application 1005 may be conducted partially on the server 1020 and partially at one or more locations remote from the server 1020. Further, the memory 1040 may include an operating environment, such as operating environment 1050, described below. Memory 1040 may also include other types of data, such as environment and/or application description data, application data for one or more applications, as well as data involving virtual private network (VPN) applications or services, firewall policies, a security or access log, print or other reporting files, HyperText Markup Language (HTML) files or templates, related or unrelated software applications or sub-systems, and others. Consequently, memory 1040 may also be considered a repository of data, such as a local data repository from one or more applications.

Server 1020 may also include processor 1060. Processor 1060 executes instructions and manipulates data to perform the operations of the server 1020 and may be, for example, a central processing unit (CPU), a blade, an application specific integrated circuit (ASIC), or a field-programmable gate array (FPGA). Although FIG. 1 illustrates a single processor 1060 in server 1020, multiple processors 1060 may be used according to particular needs and reference to processor 1060 is meant to include multiple processors 1060 where applicable. In the illustrated embodiment, processor 1060 executes the alcohol aging application 1005.

Server 1020 may also include interface 1070 for communicating with other computer systems, such as computer 1030, over network 1010 in a client-server or other distributed environment. In certain embodiments, server 1020 receives data from internal or external senders through interface 1070 for storage in memory 1040 and/or processing by processor 1060. Generally, interface 1070 comprises logic encoded in software and/or hardware in a suitable combination and operable to communicate with network 1010. More specifically, interface 1070 may comprise software supporting one or more communications protocols associated with communications network 1010 or hardware operable to communicate physical signals.

Network 1010 facilitates wireless or wireline communication between computer server 1020 and any other local or remote computer, such as clients 1030. Network 1010 may be all or a portion of an enterprise or secured network. In another example, network 1010 may be a VPN merely between server 1020 and client 1030 across wireline or wireless link. Such an example wireless link may be via 802.11a, 802.11b, 802.11g, 802.20, WiMax, and many others. While illustrated as a single or continuous network, network 1010 may be logically divided into various sub-nets or virtual networks without departing from the scope of this disclosure, so long as at least a portion of network 1010 may facilitate communications between server 1020 and at least one client 1030. For example, server 1020 may be communicably coupled to a repository 1080 through one sub-net while communicably coupled to a particular client 1030 through another. In other words, network 1010 encompasses any internal or external network, networks, sub-network, or combination thereof operable to facilitate communications between various computing components in system 1000. Network 1010 may communicate, for example, Internet Protocol (IP) packets, Frame Relay frames, Asynchronous Transfer Mode (ATM) cells, voice, video, data, and other suitable information between network addresses. Network 1010 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 1010 may be a secure network accessible to users via certain local or remote computers 1030.

Computer 1030 may be any computing device operable to connect or communicate with server 1020 or network 1010 using any communication link At a high level, each client 1030 includes or executes at least graphical user interface (“GUI”) 1090 and comprises an electronic computing device operable to receive, transmit, process and store any appropriate data associated with system 1000. It will be understood that there may be any number of computers 1030 communicably coupled to server 1020. Further, “computer 1030” and “user” may be used interchangeably as appropriate without departing from the scope of this disclosure. Moreover, for ease of illustration, each computer 1030 is described in terms of being used by one user. But this disclosure contemplates that many users may use one computer or that one user may use multiple computers. As used in this disclosure, computer 1030 is intended to encompass a personal computer, touch screen terminal, workstation, network computer, kiosk, wireless data port, smart phone, personal data assistant (PDA), one or more processors within these or other devices, or any other suitable processing device. For example, computer 1030 may be a PDA operable to wirelessly connect with an external or unsecured network. In another example, computer 1030 may comprise a laptop computer that includes an input device, such as a keypad, touch screen, mouse, or other device that can accept information, and an output device that conveys information associated with the operation of server 1020 or computer 1030, including digital data, visual information, or user interface, such as the GUI 1090. Both the input device and output device may include fixed or removable storage media such as a magnetic computer disk, CD-ROM, or other suitable media to both receive input from and provide output to users of computer 1030 through the display, for example GUI 1090.

GUI 1090 may include a graphical user interface operable to allow the user of client 1030 to interface with at least a portion of system 1000 for any suitable purpose, such as interfacing with alcohol aging application 1050, viewing data associated with the alcohol aging application 1005 or other data, or for otherwise interacting with the accelerated aging system 10. For example, GUI 1090 could present a user the ability to select a preprogrammed accelerated aging procedure. For example, a preprogrammed accelerated aging procedure may define the amount of the different components forming the solution 90, temperatures and/or pressure to be applied to the mixture, the times at which those temperatures and pressure are to be applied to the mixture, the amount and pressure of an oxygen-containing gas or other chemical is to be applied to the solution 90, the duration of the accelerated aging process, or other aspect of the accelerated aging process (e.g., one or more of the aspects described above). Additionally, the GUI 1090 may provide for a user to alter one or more of the aspects of an accelerated aging process individually as well as create an accelerated aging procedure.

Generally, GUI 1090 may provide a particular user with an efficient and user-friendly presentation of data provided by or communicated within system 1000. GUI 1090 may include a plurality of customizable frames or views having interactive fields, pull-down lists, and buttons operated by the user. GUI 1090 may also present a plurality of portals or dashboards. It should be understood that the term graphical user interface may be used in the singular or in the plural to describe one or more graphical user interfaces and each of the displays of a particular graphical user interface. Indeed, reference to GUI 1090 may indicate a reference to the front-end or a component of alcohol aging application 1005, as well as the particular interface accessible via computer 1030, as appropriate, without departing from the scope of this disclosure.

Therefore, GUI 1090 contemplates any graphical user interface. For example, in some instances, the GUI 1090 may include a generic web browser or touch screen that processes information in system 100 and efficiently presents the results to the user. In other instances, the GUI 1090 may include a custom or customizable interface for displaying and/or interacting with the various features of the application 1005. Further, in some instances, server 1020 may accept data from computer 1030 and return the appropriate HTML or XML responses to the browser using network 1010. In some instances, data between the server and the computer 1030 may be transmitted via a web browser (e.g., Microsoft Internet Explorer or Netscape Navigator) or other application. In some instances, software utilized for transmitted data may be integrated within the alcohol aging application 1050 and application 1005.

Although this disclosure has been described in terms of certain implementation and generally associated methods, alterations and permutations of these implementations and methods will be apparent to those skilled in the art. Accordingly, other implementations are within the scope of the following claims.

What is claimed is:

1. A system for aging alcohol, comprising:
a first pressure vessel configured to hold a first mixture including an ethanol-based solution and an organic compound and maintain a pressure above atmospheric pressure for a first period of time;
a second pressure vessel configured to hold a second mixture including an ethanol-based solution and an organic compound and maintain a pressure above atmospheric pressure for a second period of time; and
a control system configured to increase reaction rates of components in the first mixture for the first period of time and, in response to an end of the first period of time, increase the reaction rates of components in the second mixture for a second period of time, the second period of time after the first period of time, the reaction rates increased relative to a conventional aging process.

2. The system of claim 1, further comprising a vapor collection unit configured to capture vapor from the first pressure vessel during or after depressurization and introduce the captured vapor into the second pressure vessel prior to an end of the second period of time.

3. The system of claim 1, further comprising a heat exchanger configured to transfer heat from distillation of an ethanol-based solution to at least one of the first mixture in the first pressure vessel or the second mixture in the second pressure vessel.

4. The system of claim 1, wherein the heat is transferred from waste liquid of the distillation.

5. The system of claim 1, further comprising a filter configured to filter the organic compound from the ethanol-based solution in the first vessel in connection with the end of the first period of time.

6. The system of claim 5, further comprising a heat exchanger configured to capture heat from the filtered ethanol-based solution and add at least a portion of the captured heat to the ethanol-based solution and the organic compound in the second vessel prior to an end of the second period of time.

7. The system of claim 5, further comprising a carbon unit configured to form carbon from the filtered organic compound, wherein the formed carbon is added to the second pressure vessel prior to an end of the second period of time.

8. The system of claim 5, further comprising a water supply for the second pressure vessel configured to heat water using the captured heat from the heat exchanger and adding the heated water to the second vessel prior to an end of the second period of time.

9. The system of claim 5, further comprising a distillation unit configured to distill alcohol from the filtered organic material.

10. The system of claim 5, further comprising a flavoring unit configured to add compound from the filtered organic material to one or more liquids to form a flavored beverage.

11. The system of claim 5, further comprising an extraction unit configured to combine alcohol from the filtered organic material with water by flushing water through the filtered organic material and adding the combined alcohol and water to the filtered ethanol-based solution.

12. The system of claim 1, wherein the first mixture and the second mixture have an alcohol by volume (ABV) of about 40% or greater.

13. The system of claim 1, wherein the system includes three or more pressure vessels.

14. A method for aging alcohol comprising:
introducing a volume of a first mixture comprising an ethanol-based solution and an organic compound into a first vessel;
increasing a pressure of the first mixture above atmospheric pressure for a first period of time;
introducing a volume of a second mixture comprising an ethanol-based solution and an organic compound into a second vessel;
increasing a pressure of the second mixture above atmospheric pressure for a second period of time, the first period of time different from the second period of time.

15. The method of claim 14, further comprising:
depressurizing the first mixture;
collecting a vapor produced by the first mixture during or after depressurization of the first mixture; and
introducing the collected vapor into the second vessel prior to an end of the second period of time.

16. The method of claim 14, further comprising transferring an amount of heat from an alcohol distillation process to at least one of the first mixture in the first vessel or the second mixture in the second vessel.

17. The method of claim 16, wherein the heat from an alcohol distillation process comprises heat from a waste liquid of the alcohol distillation process.

18. The method of claim 14, further comprising filtering the organic compound from the ethanol-based solution in the first vessel in connection with the end of the first period of time.

19. The method of claim 18, further comprising:
forming carbon from at least a portion of the filtered organic compound; and
introducing the carbon into the second vessel prior to an end of the second period of time.

20. The method of claim 18, further comprising:
extracting one or more flavoring compounds from the filtered organic compound; and
introducing the one or more flavoring compounds into one or more liquids to form a flavored beverage.

21. The method of claim 14, wherein the first mixture and the second mixture have an alcohol by volume (ABV) of about 4% or greater.
